(19) United States
(12) Patent Application Publication
(10) Pub. No.: US 2021/0073335 A1
(43) Pub. Date: Mar. 11, 2021

(54) METHODS AND SYSTEMS FOR SEMANTIC ANALYSIS OF TABLE CONTENT

(71) Applicant: INTERNATIONAL BUSINESS MACHINES CORPORATION, Armonk, NY (US)

(72) Inventors: Yufang HOU, DUBLIN (IE); Charles JOCHIM, DUBLIN (IE); Martin GLEIZE, DUBLIN (IE); Debasis GANGULY, DUBLIN (IE)

(73) Assignee: INTERNATIONAL BUSINESS MACHINES CORPORATION, Armonk, NY (US)

(21) Appl. No.: 16/564,136

(22) Filed: Sep. 9, 2019

(51) Int. Cl. G06F 17/27; G06F 16/23

(52) U.S. Cl. CPC G06F 17/2785; G06F 16/2379

(57) ABSTRACT

Embodiments for semantic analysis of table content are provided. A document that includes a table portion and a non-table portion is received. A table result within the table portion of the document is identified. Contextual content associated with the table result is extracted from the non-table portion of the document. A data structure is generated for the table result. The data structure includes the table result and the contextual content associated with the table result.

### BACKGROUND OF THE INVENTION

### Field of the Invention

The present invention relates in general to computing systems, and more particularly, to various embodiments for generating a semantic understanding of the contents of document tables.

### Description of the Related Art

Generally, natural language processing (NLP) is a subfield of linguistics, computer science, information engineering, and/or artificial intelligence concerned with the interactions between computers and human (or natural or spoken/written) languages. In particular, NLP deals with how to program computer systems, for example, read, decipher, understand, make sense of, and/or otherwise process human languages in a manner that is valuable. Most NLP techniques rely on machine learning (or cognitive analysis, artificial intelligence, etc.) to derive meaning from human languages. NLP processes often involve (or utilize) semantic role labeling (or semantic parsing), which includes assigning labels (e.g., agent, goal, result, etc.) to words or phrases that indicate their semantic role in sentences.

Although significant improvements to NLP processes, and semantic role labeling, have been made in recent years, generally speaking, the techniques focus on the analysis of the “text” of documents, such as introductory sections, main bodies/text portions, conclusions, etc. In contrast, little effort has been applied to utilization of such processes for analyzing the content of tables, graphs, figures, etc. within documents.

### SUMMARY OF THE INVENTION

Various embodiments for semantic analysis of table content, by a processor, are provided. A document that includes a table portion and a non-table portion is received. A table result within the table portion of the document is identified. Contextual content associated with the table result is extracted from the non-table portion of the document. A data structure is generated for the table result. The data structure includes the table result and the contextual content associated with the table result.

In addition to the foregoing exemplary embodiment, various other system and computer program product embodiments are provided and supply related advantages. The foregoing Summary has been provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary computing node according to an embodiment of the present invention;

FIG. 2 is an additional block diagram depicting an exemplary cloud computing environment according to an embodiment of the present invention;

FIG. 3 is an additional block diagram depicting abstraction model layers according to an embodiment of the present invention;

FIG. 4 is a block diagram of an initial processing method and/or system for semantic analysis of table content according to embodiment of the present invention;

FIG. 5 is a block diagram of a method and/or system for semantic analysis of table content according to embodiment of the present invention;

FIGS. 6, 7, and 8 are plan views of pages of an exemplary document according to an embodiment of the present invention;

FIG. 9 is a simplified illustration of an exemplary table extraction process performed on the document pages of FIGS. 6, 7, and 8 according to an embodiment of the present invention;

FIG. 10 is a simplified illustration of an exemplary contextual content extraction process performed on the document pages of FIGS. 6, 7, and 8 and a resulting data structure according to an embodiment of the present invention;

FIG. 11 is a simplified illustration of an exemplary process of identifying arguments within the extracted contextual content of FIG. 10 according to an embodiment of the present invention;

FIG. 12 is a diagram showing semantic roles assigned to the identified arguments of FIG. 11 according to an embodiment of the present invention; and

FIG. 13 is a flowchart diagram of an exemplary method for semantic analysis of table content according to an embodiment of the present invention.

### DETAILED DESCRIPTION OF THE DRAWINGS

As discussed above, natural language processing (NLP) is a subfield of linguistics, computer science, information engineering, and/or artificial intelligence concerned with the interactions between computers and human (or natural or spoken/written) languages. In particular, NLP deals with how to program computer systems to, for example, read, decipher, understand, make sense of, and/or otherwise process human languages in a manner that is valuable. Most NLP techniques rely on machine learning (or cognitive analysis, artificial intelligence, etc.) to derive meaning from human languages.

NLP processes often involve (or utilize) semantic role labeling (or semantic parsing), which includes assigning labels (e.g., agent, goal, result, etc.) to words or phrases that indicate their semantic role in sentences. More specifically, semantic role labeling may include detecting (or identifying) semantic arguments associated with a predicate (or verb) of a sentence and classifying the arguments to their specific roles, as is commonly understood. For example, given the sentence “Mary sold the book to John,” a semantic role labeling system may recognize the verb (or verb phrase) “to sell” as representing the predicate, “Mary” as representing the seller (or agent), “the book” as representing the goods (or theme or product), and “John” as representing the buyer (or recipient).

Although significant improvements to NLP processes, and semantic role labeling, have been made in recent years, generally speaking, the techniques focus on the analysis of the “text” of documents, such as introductory sections, main bodies/text portions, conclusions, etc. In contrast, little effort has been applied to utilization of such processes for analyzing the content of tables, graphs, figures, etc. within documents.

More specifically, current semantic role labeler systems are generally only applied to processing text, as opposed to, for example, table results (e.g., numbers, etc. located in table cells). That is, current NLP techniques do not provide for the semantic understanding of results reported (or listed, included, etc.) in document tables. In other words, current NLP (and/or semantic role labeling) techniques generally only process “text” (or “non-table” portions of) documents, do not consider (or “treat” or process) table results (from “table portions” of documents) as predicates, and do not consider elements associated with tables as candidate arguments, let alone determine semantic roles for such arguments (and/or the results).

To address these needs and/or the shortcomings in the prior art, in some embodiments described herein, methods and/or systems are disclosed that, for example, provide for the labeling of semantic roles for results reported in document tables and/or the identified semantic arguments thereof, as well as semantic role grounding for extracted semantic role representations to corresponding entries in a database (or knowledge base), as is described in greater detail below.

For the purposes of this description, “database” (or “knowledge base”) may refer to any store of data (e.g., data stored on any suitable memory) related to or associated with any subject(s), concept(s), etc. or interest (e.g., particular scientific fields, economics, medicine, politics, athletics, etc.), such as an online database or website. As described above, with respect to semantic role labeling, a “predicate” may refer to a verb, verb phrase, event, etc., which are typically found in, for example, sentences or phrases within documents. However, in some embodiments described herein, table results (e.g., the contents of table cells) may be processed (or treated, handled, etc.) in a manner similar to how predicates are conventionally processed when semantic role labeling is performed on sentences, phrases, etc., as described in greater detail below. “Arguments” may refer to entities that are associated with predicates (and/or table results), and “semantic roles” may refer to the roles of arguments and/or the relationship the arguments have to respective predicates (or table results), as will be appreciated by one skilled in the art. “Semantic role labeling” (SLR) may refer to the determining of semantic roles of arguments, as described above. “Semantic role grounding” may refer to the generation of associations (or “links”) between semantic role representations (e.g., arguments) to the corresponding concept entry in a database.

Additionally, “table portions” (or “cell portions”) of documents may refer to portions of documents that include cells of tables and/or the results listed, reported, etc. within the cells of tables (e.g., numeric values, etc.). “Non-table portions” (or “non-cell portions”) of documents may refer to the portions of the documents that are external to table cells. In other words, non-table portions of documents may include any portion of documents besides table cells, such as titles, authors, document texts/main bodies, introductions, abstracts, conclusions, citations/references, as well as table row and/or column headers and table captions (and/or the content, text, etc. thereof).

In some embodiments described herein, table results (or “results”) within one or more document may be considered to be processed as predicates in a semantic role labeling technique. Contextual content associated with the semantic understanding of the predicates (or results) is identified within and/or extracted from non-table portions of the document(s). Arguments associated with the predicates (or results) may be identified within the extracted contextual content. Semantic roles may then be determined for each of the arguments. The arguments may be “linked” to entries within suitable databases (or knowledge bases) (e.g., semantic role grounding). A data structure may be generated for each of the results, which includes, for example, the respective result and the associated contextual content, arguments, semantic roles, and/or the semantic role grounding (e.g., the generated “links”). Such an output (e.g., the data structure(s) and/or the content thereof) may then be utilized in a NLP processing technique.

In some embodiments, the methods and systems described herein may utilize a domain-dependent semantic scheme that is related to the subject/area with which processed document(s) is associated (e.g., science, economics, etc.). The domain-dependent scheme may include keywords, phrases, terms, etc. that are typically utilized within the respective subject, along with (predetermined) semantic roles that are suitable for and/or associated with the subject of the document(s).

In some embodiments, one or more documents to be processed are received and/or retrieved. The document(s) may be, for example, a Portable Document Format (PDF) document, a Hypertext Markup Language (HTML) document, an Extensible Markup Language (XML) document, or any other suitable type of electronic document. The document may include at least one table (or cell) portion and at least one non-table (or non-cell) portion, as described above.

The document(s) is processed or analyzed to identify the text and table(s) therein (and/or differentiate the table portion(s) from the non-table portion(s)), as will be appreciated by one skilled in the art. For each table, the results (e.g., the contents of the cells) are extracted (i.e., from the table portion(s) of the document). For each of the results, contextual content is extracted, such as row and/or column headers and table captions that are associated with the table (i.e., from the non-table portion(s) of the document). Additionally, in some embodiments, at least some of the contextual content is extracted from other portions of the document, such as the main body/text, introduction, etc., which is determined to be associated with the respective table and/or the result. Within the extracted contextual content, one or more arguments or semantic role representations (e.g., entities) associated with the result is identified. In some embodiments, a semantic role for each of the arguments is determined (e.g., selected from a predetermined set of semantic roles associated with the subject of the document), and each of the arguments is linked (e.g., via a hyperlink) to a corresponding entry in a database (e.g., a remote database, via a communications network, etc.).

In some embodiments, a data structure (e.g., a table) is generated for each result. The data structure may include the result and the associated contextual content (e.g., table headers, table caption, other text from the document, etc.), identified arguments, determined semantic roles for the arguments, and/or the semantic role grounding links.

At least some of the aspects of functionality described herein may be performed utilizing a cognitive analysis (or machine learning technique). The cognitive analysis may include natural language processing (NLP) or a NLP technique, such classifying natural language, analyzing tone, and analyzing sentiment (e.g., scanning for keywords, key phrases, etc.) with respect to, for example, content (or data), communications sent to and/or received by users, and/or other available data sources. In some embodiments, natural language processing (NLP), Mel-frequency cepstral coefficients (MFCCs) (e.g., for audio content detected by a microphone), and/or region-based convolutional neural network (R-CNN) pixel mapping (e.g., for object detection/classification in images/videos), as are commonly understood, are used.

The processes described herein may utilize various information or data sources associated with users and/or content. With respect to users, the data sources may include, for example, any available data sources associated with the user. For example, in some embodiments, a profile (e.g., a cognitive profile) for the user(s) may be generated. Data sources that may be use used to generate a cognitive profile for the user(s) may include any appropriate data sources associated with the user that are accessible by the system (perhaps with the permission or authorization of the user). Examples of such data sources include, but are not limited to, communication sessions and/or the content (or communications) thereof (e.g., chatbot interactions, phone calls, video calls, text messaging, emails, in person/face-to-face conversations, etc.), a profile of (or basic information about) the user (e.g., job title, place of work, length of time at current position, family role, etc.), a schedule or calendar (i.e., the items listed thereon, time frames, etc.), projects (e.g., past, current, or future work-related projects), location (e.g., previous and/or current location and/or location relative to other users), social media activity (e.g., posts, reactions, comments, groups, etc.), browsing history (e.g., web pages visited), and online purchases.

As such, in some embodiments, the methods and/or systems described herein may utilize a “cognitive analysis,” “cognitive system,” “machine learning,” “cognitive modeling,” “predictive analytics,” and/or “data analytics,” as is commonly understood by one skilled in the art. Generally, these processes may include, for example, receiving and/or retrieving multiple sets of inputs, and the associated outputs, of one or more systems and processing the data (e.g., using a computing system and/or processor) to generate or extract models, rules, etc. that correspond to, govern, and/or estimate the operation of the system(s), or with respect to the embodiments described herein, semantically analyzing table content, as described herein. Utilizing the models, the performance (or operation) of the system (e.g., utilizing/based on new inputs) may be predicted and/or the performance of the system may be optimized by investigating how changes in the input(s) effect the output(s). Feedback received from (or provided by) users and/or administrators may also be utilized, which may allow for the performance of the system to further improve with continued use.

It should be understood that as used herein, the term “computing node” (or simply “node”) may refer to a computing device, such as a mobile electronic device, desktop computer, etc. and/or an application, such as a chatbot, an email application, a social media application, a web browser, etc. In other words, as used herein, examples of computing nodes include, for example, computing devices such as mobile phones, tablet devices, desktop computers, or other devices, such as appliances (IoT appliances) that are owned and/or otherwise associated with individuals (or users), and/or various applications that are utilized by such computing devices.

Additionally, although particular embodiments and examples described herein may describe semantically analyzing table content, it should be understood that the methods and system described herein may be applied to other types of “non-text” content or diagrams in documents, such as graphs, charts, and images/figures.

In particular, in some embodiments, a method for semantic analysis of table content, by a processor, is provided. A document that includes a table portion and a non-table portion is received. A table result within the table portion of the document is identified. Contextual content associated with the table result is extracted from the non-table portion of the document. A data structure is generated for the table result. The data structure includes the table result and the contextual content associated with the table result.

The table portion of the document may include a cell of a table within the document. The non-table portion of the document may include at least one of a header of the table, a caption associated with the table, and document text (e.g., introduction, main body, etc.). The non-table portion of the document may include document text.

At least one argument associated with the table result within the extracted contextual content may be identified. A semantic role for each of the at least one argument associated with the table result may be determined.

A domain semantic scheme associated with a subject of the document may be received. The domain semantic scheme may include a plurality of semantic roles. The determined semantic role for each of the at least one argument may be selected from the plurality of semantic roles.

An association between each of the at least one argument and an entry corresponding to the respective argument in a database may be generated. The document may include at least one of a Portable Document Format (PDF) document, a Hypertext Markup Language (HTML) document, and an Extensible Markup Language (XML) document

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment, such as cellular networks, now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

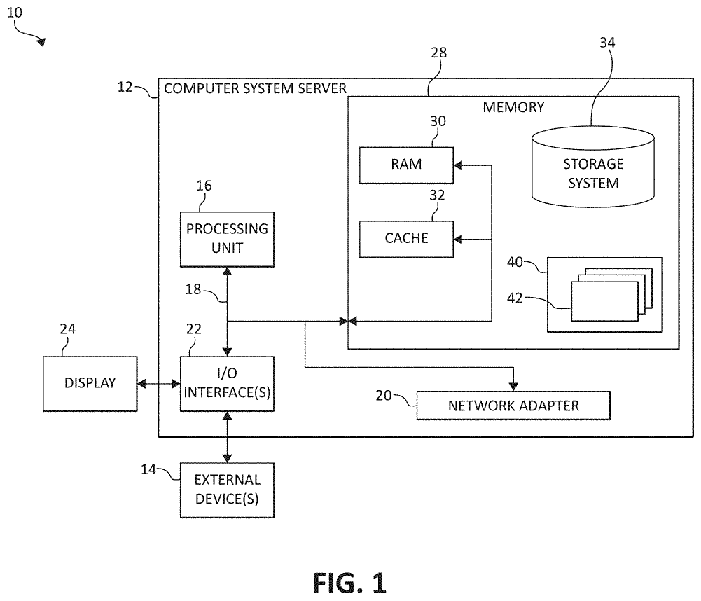

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 (and/or one or more processors described herein) is capable of being implemented and/or performing (or causing or enabling) any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32.

Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

In the context of the present invention, and as one of skill in the art will appreciate, various components depicted in FIG. 1 may be located in, for example, personal computer systems, server computer systems, thin clients, thick clients, hand-held or laptop devices, multiprocessor systems, microprocessor-based systems, set top boxes, programmable consumer electronics, network PCs, mobile electronic devices such as mobile (or cellular and/or smart) phones, personal data assistants (PDAs), tablets, wearable technology devices, laptops, handheld game consoles, portable media players, etc., as well as computing systems in vehicles, such as automobiles, aircraft, watercrafts, etc. However, in some embodiments, some of the components depicted in FIG. 1 may be located in a computing device in, for example, a satellite, such as a Global Position System (GPS) satellite. For example, some of the processing and data storage capabilities associated with mechanisms of the illustrated embodiments may take place locally via local processing components, while the same components are connected via a network to remotely located, distributed computing data processing and storage components to accomplish various purposes of the present invention. Again, as will be appreciated by one of ordinary skill in the art, the present illustration is intended to convey only a subset of what may be an entire connected network of distributed computing components that accomplish various inventive aspects collectively.

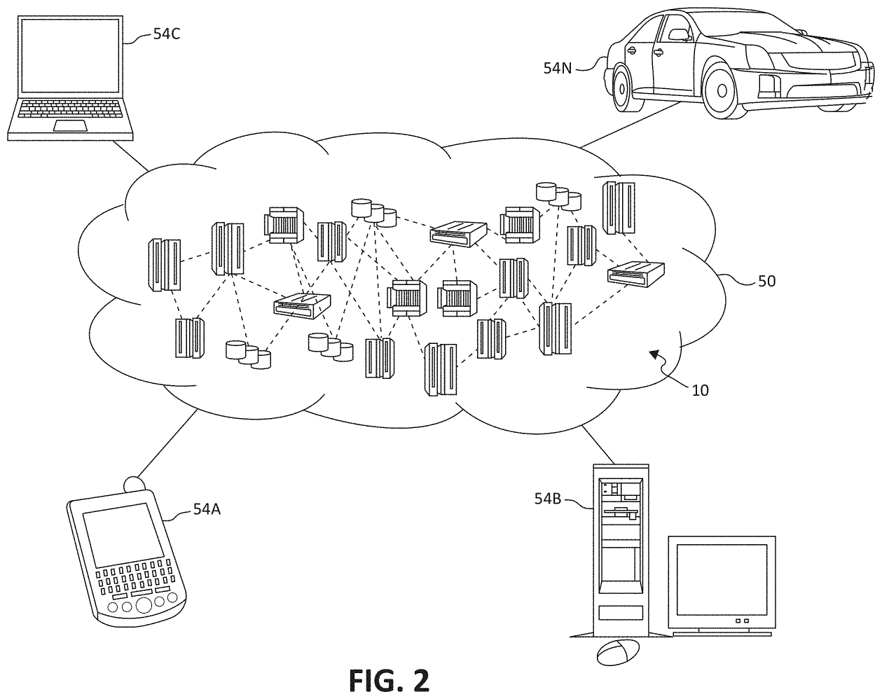

Referring now to FIG. 2, illustrative cloud computing environment 50 is depicted. As shown, cloud computing environment 50 comprises one or more cloud computing nodes 10 with which local computing devices used by cloud consumers, such as, for example, cellular (or mobile) telephone or PDA 54A, desktop computer 54B, laptop computer 54C, and vehicular computing system (e.g., integrated within automobiles, aircraft, watercraft, etc.) 54N may communicate.

Still referring to FIG. 2, nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

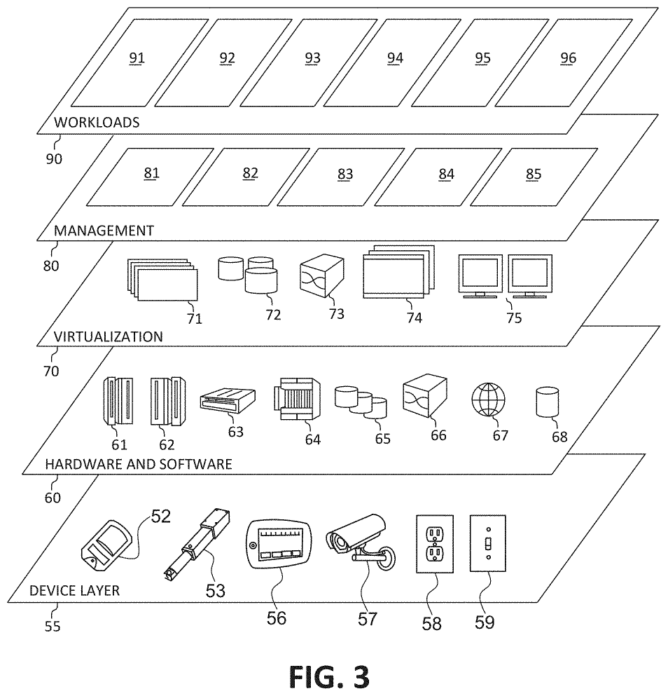

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to, various additional sensor devices, networking devices, electronics devices (such as a remote control device), additional actuator devices, so called “smart” appliances such as a refrigerator, washer/dryer, or air conditioning unit, and a wide variety of other possible interconnected devices/objects.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for semantically analyzing table content, as described herein. One of ordinary skill in the art will appreciate that the workloads and functions 96 may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

As previously mentioned, in some embodiments, methods and/or systems are provided that, for example, semantically analyze table content. In some embodiments described herein, table results (or “results”) within one or more document are (essentially) processed as predicates, as will be appreciated by one skilled in the art. Contextual content associated with the semantic understanding of the predicates (or results) is identified within and/or extracted from non-table portions of the document(s). Arguments associated with the predicates (or results) may be identified within the extracted contextual content. Semantic roles may then be determined for each of the arguments. The arguments may be linked to entries within suitable databases (or knowledge bases). A data structure may be generated for each of the results, which includes, for example, the respective result, the contextual content, the arguments, the semantic roles, and/or the semantic role grounding (e.g., the generated “links”). Such an output (e.g., the data structure(s) and/or the content thereof) may then be utilized in a NLP processing technique.

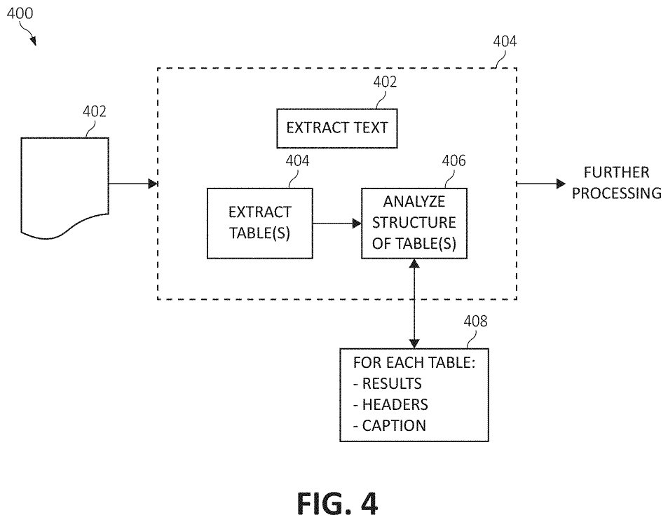

FIG. 4 illustrates a method (and/or system) 400 for semantically analyzing tables (or table content), according to an embodiment of the present invention. In particular, the method 400 shown in FIG. 4 may be understood to include an initial processing (or “pre-processing”) stage according to some embodiments described herein. As shown, a document 400 (or set of documents) is received (or retrieved) by a pre-processing module 404. The document 400 may be any type of suitable document, such as a PDF, HTML, or XML document, and include at least one table, along with other text portions, such as an abstract, introduction, main body, etc. As described above, the cells (and/or the content thereof) within the table(s) may be considered to form a table portion of the document, while the other portions of the document may be considered to form a non-table portion of the document (which may include headers of the table and a caption of the table, along with the other text portions of the document, such as the main body, etc.).

As shown, at block 402, the pre-processing module 404 extracts the text of the document 402. This process may include identifying all of the text of the document that is not included “within” (or directly associated with) the table of the document (e.g., introduction, main body, conclusion, etc.), extracting the text, and storing the text. All of the text extracted at block 402 may be extracted from the non-table portion(s) of the document, as defined above.

At block 404, the table(s) within the document 402 is extracted. This process may include identifying the table, including the cells of the table (and/or the content thereof) along with any text that is included within (or in direct association with) the table, such as headers (e.g., row and column headers) and a caption of the table. At block 406, the structure of the table is analyzed. In the example shown, at block 408, this process includes extracting the result(s) from the cells of the table (e.g., numerical values), as well as extracting the headers and caption from the table (if included as part of the table). As defined above, the cells of the table (and/or the content thereof) may be extracted from the table portion(s) of the document, while the header(s) and caption(s) may be extracted from the non-table portion(s) of the document.

The content extracted (or identified) by the pre-processing module 404 may be appropriated tagged or labeled and further processed as described below.

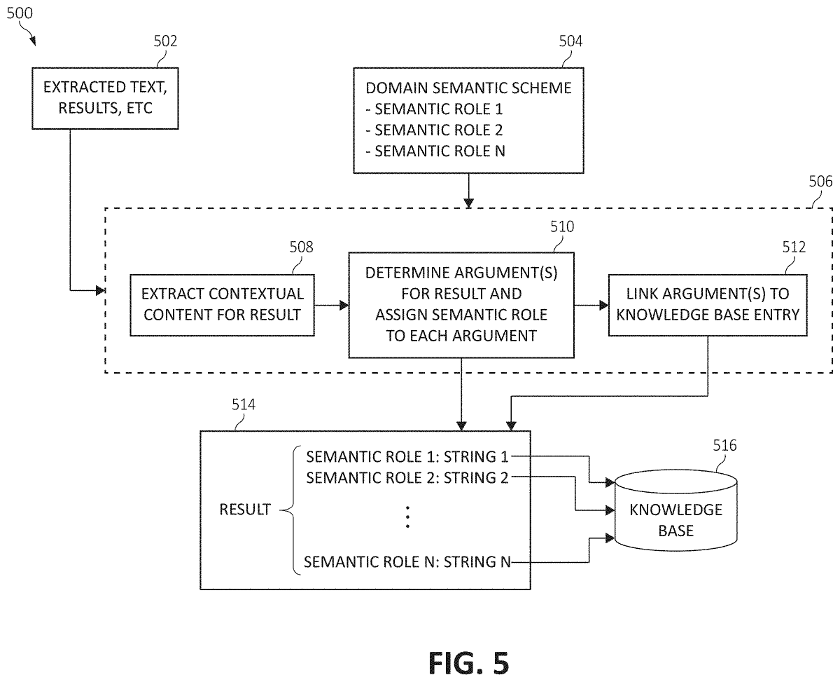

Referring now to FIG. 5, a method (and/or system) 500 for (further) semantic analysis of tables (or table content), according to an embodiment of the present invention, is shown. It should be understood that the process depicted in FIG. 5 may be performed with respect to each of the extracted table results (e.g., the content of each table cell).

At block 502, the extracted text, results, etc. (i.e., described above with respect to FIG. 4) and a domain semantic scheme 504 are received (or retrieved) by an analysis module 506. Within the analysis module 506, at block 508, contextual content for (or associated with) a result (i.e., a result within a particular table cell) is extracted from the extracted text and extracted tables. In particular, the contextual content may include text, symbols, equations, etc. from the non-table portion of the document. For example, the contextual content for a particular result may include headers and a caption of the respective table (i.e., from which the result was extracted), along with other text from the document, such as the abstract and excerpts from the main body that are determined to be associated with the result (and/or the respective table). For example, if the respective table is listed as (or titled) “Table 1” in the document, the system may identify excerpts from the main body that are associated with that table by identifying a phrase such as “As shown in Table 1 . . . ”

As described above, in some embodiments, the table results are processed in a manner similar to predicates. As such, at block 510, arguments for the result (or “predicate”) are determined or identified within the contextual content for (or associated with) the result. This process may be performed by, for example, identifying entities (or entities names, descriptors, etc.) within the contextual content (e.g., identifying nouns, noun phrases, etc. within the contextual content). Additionally, at block 510, each of the arguments may be assigned a semantic role. The semantic roles utilized may be selected from a list of (predetermined) semantic roles (e.g., semantic role 1, semantic role 2, . . . , semantic role n) that are included within the domain semantic scheme 504 (i.e., as appropriate given the particular domain, subject area, etc. of the document 402). Additionally, the domain semantic scheme 504 may include terms, keywords, phrases, etc. associated with the subject area of the document 402, which may be utilized by the system in determining (or identifying) arguments.

At block 512, each of the arguments (and/or the assigned semantic role) is “linked” to a corresponding entry in a knowledge base 516 (and/or an association between each of the arguments and a corresponding entry in a knowledge base is generated). For example, the knowledge base 516 may be an online database or website that includes entries related to the subject area of the document 402. The linking of the arguments may include generating a “hyperlink” between the argument and a particular portion of a website (e.g., an entry on the website or a particular page or URL that includes information related to the concept of the argument). For example, in some embodiments, NLP entity linking, as is commonly understood, is utilized.

The output of the analysis module 506 may include a data structure 514 (e.g., a table) that includes the result (or “predicate”), the arguments, the semantic roles assigned to the arguments, as well as the generated association(s) to the knowledge base 516. As alluded to above, such a data structure may be generated for each of the results of the table(s). The data structure(s) may then be utilized to generate an understanding of the data provided by the table(s) (e.g. via a NLP technique), as is commonly understood.

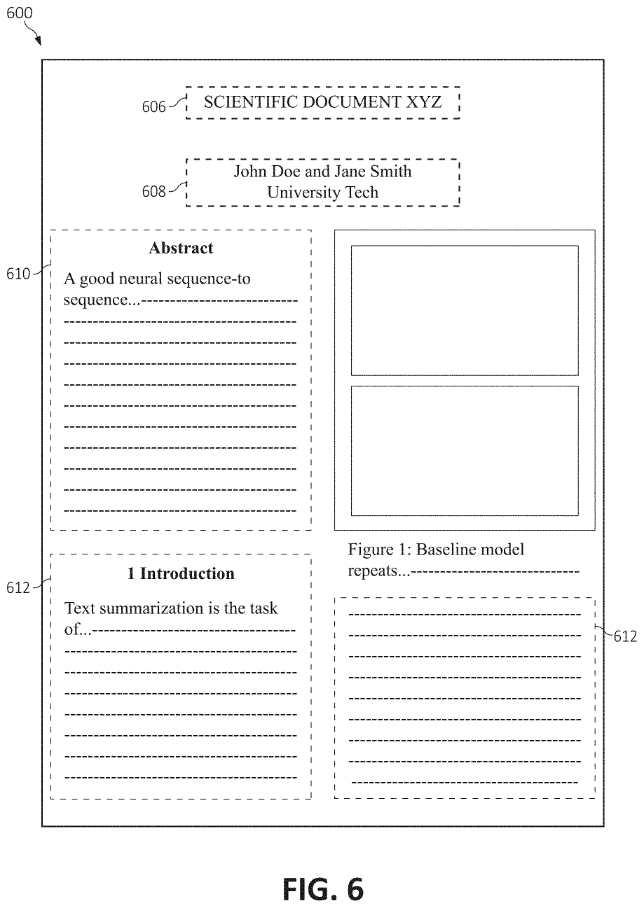

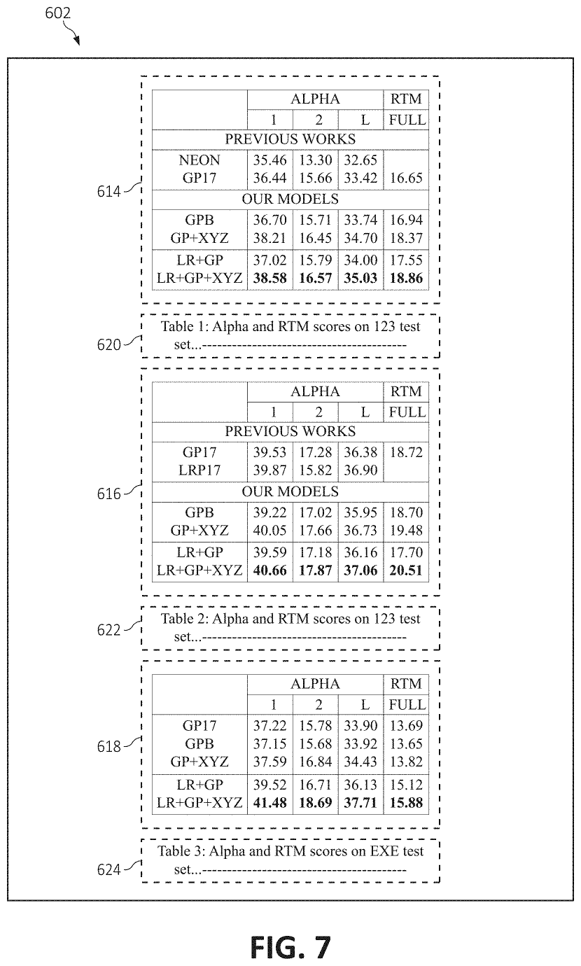

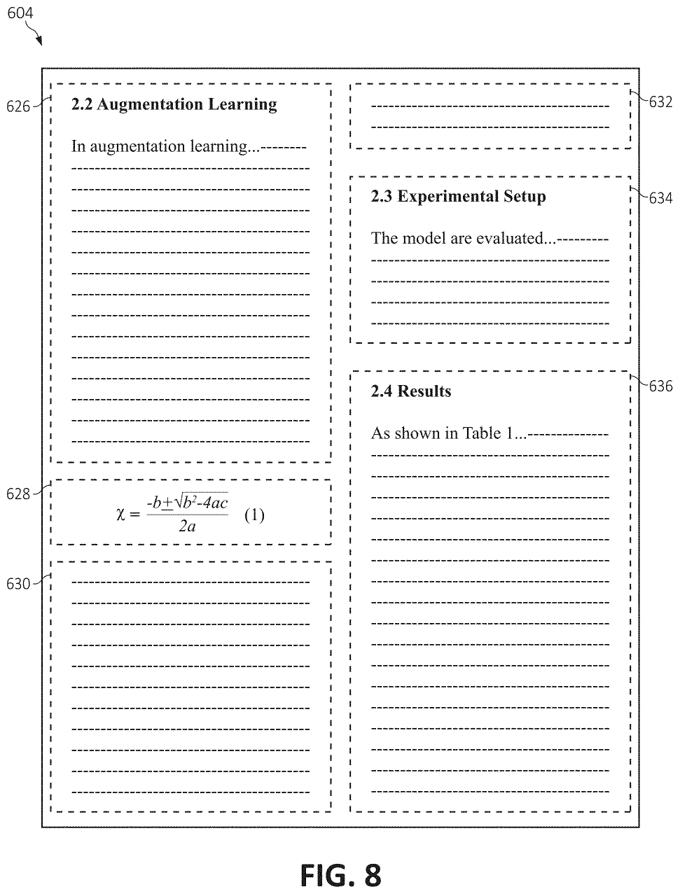

FIGS. 6, 7, and 8 illustrate pages 600, 602, and 604 of an exemplary document (e.g., an academic paper) according to an embodiment of the present invention. It should be noted that for simplicity of illustration, pages 600, 602, and 604 are shown with limited text, and other details, made visible. It should also be understood that the document may include additional pages that are not shown. In some embodiments, after the document is received, the document is processed to identify the various sections thereof, including text, tables, etc. (or table portions and non-table portions), as described above. Referring to FIGS. 6, 7, and 8 in combination, the document shown may include (or be determined to include) the following (in addition to other sections which may or may not be shown): a title (or title section) 606, an author section 608, an abstract 610, an introduction (or introduction sections) 612, tables 614, 616, and 618, table captions 620, 622, and 624 (each being associated with one of the tables 614-618), and main body sections 626-636 (which include an equation section 628).

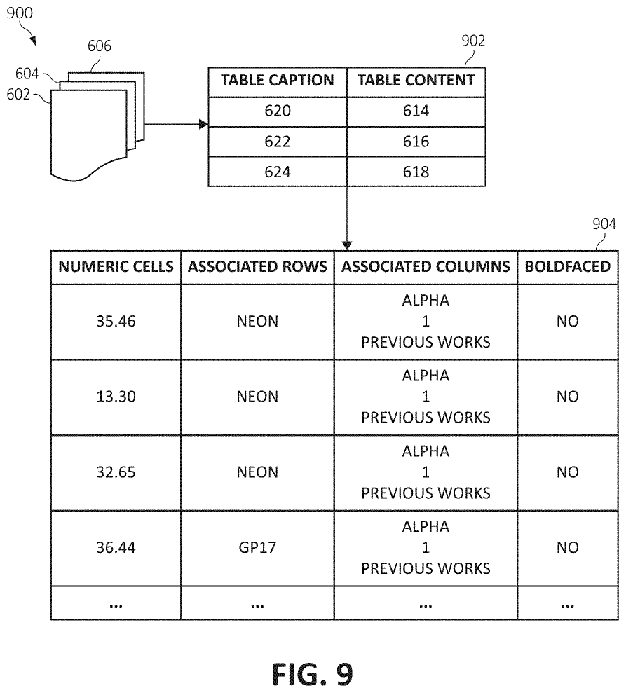

The document may be processed in a manner similar to that described above. For example, the text and tables of the document may be extracted from pages 600-604 (e.g., by a text extractor module and a table extractor module, respectively). FIG. 9 provides an illustrative example of a table extraction process 900 with respect to document pages 600, 602, and 604 (or more particularly, page 602). As shown in diagram (or table) 902, each of the table captions 620, 622, and 624 may be associated with a respective one of the tables 614, 616, and 618, which corresponds to the arrangement of the tables 614, 616, and 618 and captions 620, 622, and 624 shown on page 602 of the document (e.g., caption 620 is associated with or describes table 614, etc.). Then, as shown in diagram 904, the results (e.g., numeric cells or the contents thereof) of the tables may be extracted and associated with, for example, the appropriate rows (or row headers) and columns (or column headers) of the respective table (e.g., each result is vertically/horizontally aligned with the corresponding row/column headers in the document table). In the example shown, whether or not the results are shown in a particular style of font (e.g., bold or boldfaced) is also determined and included. It should be noted that the information shown in table 904 corresponds to table (or table section) 614 (or “Table 1”) on page 602 of the document. However, this process may be performed for each of the tables extracted from the document(s).

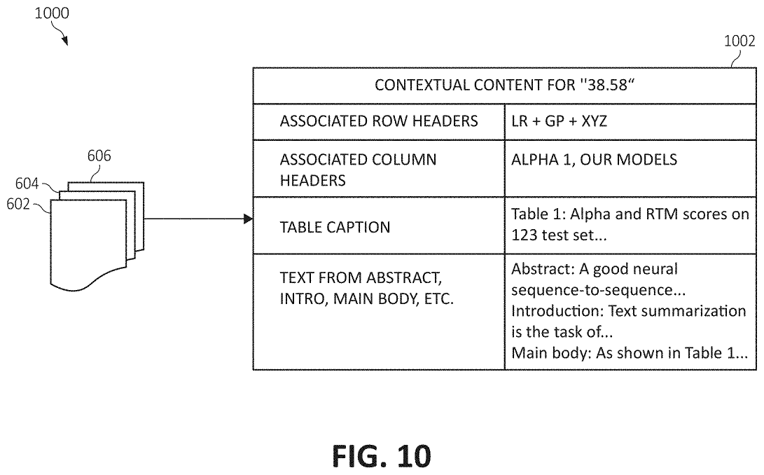

As described above, contextual content may then be extracted from the document (e.g., pages 600, 602, and 604) for each of the table results (e.g., numeric cells), which may include, for example, the appropriate headers and caption for the respective table and text (or other content) extracted from other sections of the document. FIG. 10 provides an illustrative example of a contextual content extraction process 1000, including a generated data structure (or table) 1002. The data structure 1002 may include (or be associated with) a particular result (or table cell) from a table in the processed document. In the particular example shown, the result is “38.58,” which has been extracted from table section 614 (or “Table 1”) on page 602 of the document. As shown, the data structure 1002 also includes contextual content that has been determined to be associated with that particular result. In the example shown, the contextual content includes row header(s) “LR+GP+XYZ,” column headers “Alpha 1” and “Our Models,” table caption “Table 1: Alpha and RTM scores on 123 test set . . . ,” and several sections (or excerpts thereof) from other sections of the document, the Abstract, Introduction, and Main body. It should be noted that although the Abstract and Introduction of the document may not include any specific references to the table from which result “38.58” was extracted (e.g., Table 1), the content thereof may be considered to provide information related to the table result, such as background information and/or “context” related to the result.

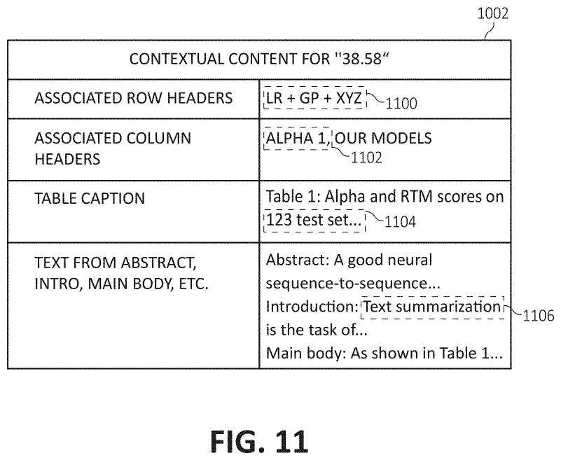

Referring now to FIG. 11, the contextual content is analyzed to identify or determine arguments for the result (e.g. “38.58”). That is, as described above, in some embodiments described herein, table results are processed as “predicates,” and arguments for the predicates (or results) are identified within the contextual content associated with the results in the analyzed document. This process may be performed by, for example, identifying entities (or entities names, descriptors, etc.) within the contextual content (e.g., identifying nouns, noun phrases, etc. within the contextual content). In the particular example shown, the identified arguments (e.g., within data structure 1002) include four arguments 1100-1106. More specifically, argument 1100 includes “LR+GP+XYZ” (from a row header), argument 1102 includes “Alpha 1” (from a column header), argument 1104 includes “123 test set” (from the table caption), and argument 1106 includes “text summarization” (from the Introduction of the document).

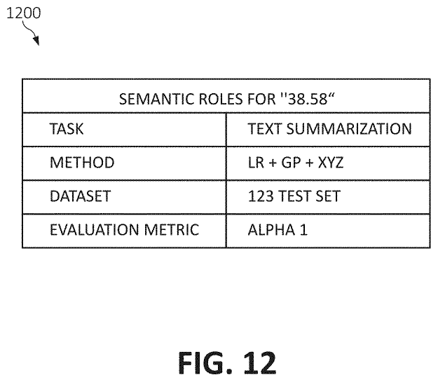

As listed in diagram (or table) 1200 in FIG. 12, a semantic role is then assigned to (or determined for) each of the arguments. In the example shown, the semantic role “task” has been assigned to argument “text summarization,” the semantic role “method” has been assigned to argument “LR+GP+XYZ,” the semantic role “dataset” has been assigned to argument “123 test set,” and the semantic role “evaluation metric” has been assigned to argument “Alpha 1.”

As described above, the semantic roles utilized may be selected from a list of (predetermined) semantic roles that are included within a received (or retrieved) domain semantic scheme (i.e., as appropriate given the particular domain, subject area, etc. of the document). Additionally, the domain semantic scheme may include terms, keywords, phrases, etc. associated with the subject area of the document, which may be utilized by the system in determining (or identifying) arguments. This process may be performed utilizing a corpus that has been generated, which includes semantic role annotations for table results (e.g., specific to the subject matter of the respective document). Additionally, the assigning of the semantic roles to the arguments may be performed utilizing a machine learning model that has been trained to assign semantic roles to tables and/or for text related to the subject matter of the respective document.

As described above, in some embodiments, each of the arguments (and/or the assigned semantic role) is “linked” to a corresponding entry in a knowledge base (and/or an association between each of the arguments and a corresponding entry in a knowledge base is generated. For example, the knowledge base may be an online database or website that includes entries related to the subject area of the respective document. The linking of the arguments may include generating a “hyperlink” between the argument and a particular portion of a website (e.g., an entry on the website or a particular page or URL that includes information related to the concept of the argument). For example, in some embodiments, NLP entity linking, as is commonly understood, is utilized.

The generated data structure(s) (e.g., one for each of the extracted table results), such as that shown in FIG. 10 (and/or FIG. 12), along with the generated links to a knowledge base (or knowledge bases), may then be utilized to generate an understanding of the data provided by the table(s) (e.g. via a NLP technique), as is commonly understood.

As such, the methods and systems described herein may receive one or more document (e.g., PDFs, HTML, and XML documents) as input and return a semantic interpretation of results in tables within the document as output. The process may include extracting structural and semantic information from each table, such as a table caption, row/column headers, and table results. Semantic role information (or contextual content) for each result may be extracted from table context (e.g. captions, headers, etc.), and perhaps other portions of the document(s) (e.g., the main body, etc.). One or more argument may be determined for each result, and a semantic role may be assigned to each argument. The arguments (and/or the assigned semantic roles) may be linked to a corresponding entry in a database (or knowledge base).

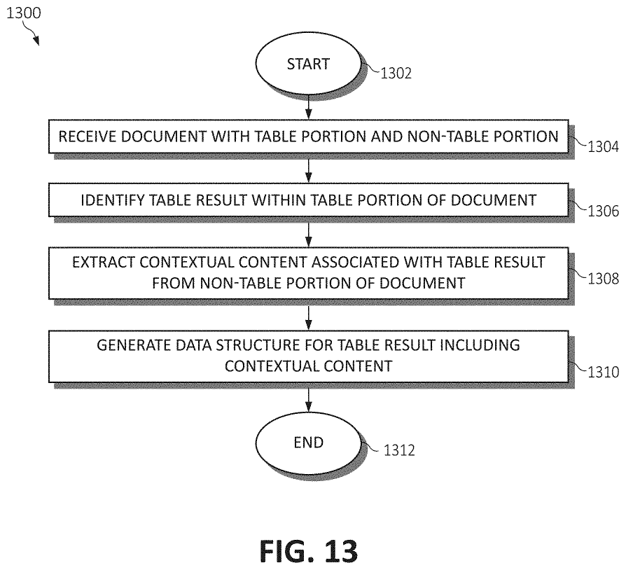

Turning to FIG. 13, a flowchart diagram of an exemplary method 1300 for semantic analysis of table content is provided. The method 1300 begins (step 1302) with, for example, with one or more domain semantic schemes being generated, with each scheme including, for example, one or more predetermined semantic role that is appropriate for a particular subject area, topic, etc.

A document (or one or more documents) that includes a table portion and a non-table portion is received (step 1304). The table portion of the document may include a cell of a table within the document. The non-table portion of the document may include at least one of a header of the table, a caption associated with the table, and document text (e.g., an abstract, introduction, main body, etc.). In some embodiments, the non-table portion of the document includes document text, along with one or more headers of the table and/or a caption of the table. The document may include, for example, at least one of a Portable Document Format (PDF) document, a Hypertext Markup Language (HTML) document, and an Extensible Markup Language (XML) document.

A table result within the table portion of the document is identified (step 1306). The table result may include the content (e.g., a numeric value) of a particular cell of the table.

Contextual content associated with the table result is extracted from the non-table portion of the document (step 1308). At least one argument associated with the table result within the extracted contextual content may be identified. A semantic role for each of the at least one argument associated with the table result may be determined. That is, the result may be processed in a manner similar to a “predicate.” A domain semantic scheme associated with (or appropriate for) a subject of the document may be received. The domain semantic scheme may include a plurality of semantic roles. The determined semantic role for each of the at least one argument may be selected from the plurality of semantic roles.

A data structure is generated for the result (step 1310). The data structure includes the table result and the contextual content associated with the result, perhaps along with the identified arguments and the determined semantic roles. An association (or “link,” such as a hyperlink) between each of the at least one argument (and/or the assigned semantic roles) and an entry corresponding to the respective argument in a database (or knowledge base, such as a website) may be generated, which may also be included in the data structure.

Method 1300 ends (step 1312) with, for example, the data structure being utilized to generate an understanding of the data provided by the table(s) (e.g. via a NLP technique), as is commonly understood. This process may be repeated for each result extracted from the table(s). In some embodiments, feedback from users may (also) be utilized to improve the performance of the system over time.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

1. A method for semantic analysis of table content, by a processor, comprising:
receiving a document that includes a table portion and a non-table portion;
identifying a table result within the table portion of the document;
extracting contextual content associated with the table result from the non-table portion of the document; and
generating a data structure for the table result, wherein the data structure includes the table result and the contextual content associated with the table result.

2. The method of claim 1, wherein the table portion of the document includes a cell of a table within the document, and wherein the non-table portion of the document includes at least one of a header of the table, a caption associated with the table, and document text.

3. The method of claim 2, wherein the non-table portion of the document includes document text.

4. The method of claim 1, further comprising:
identifying at least one argument associated with the table result within said extracted contextual content; and
determining a semantic role for each of the at least one argument associated with the table result.

5. The method of claim 4, further comprising receiving a domain semantic scheme associated with a subject of the document, wherein the domain semantic scheme includes a plurality of semantic roles, and said determined semantic role for each of the at least one argument is selected from the plurality of semantic roles.

6. The method of claim 4, further comprising generating an association between each of the at least one argument and an entry corresponding to the respective argument in a database.

7. The method of claim 1, wherein the document includes at least one of a Portable Document Format (PDF) document, a Hypertext Markup Language (HTML) document, and an Extensible Markup Language (XML) document.

8. A system for semantic analysis of table content comprising:
a processor executing instructions stored in a memory device, wherein the processor:
receives a document that includes a table portion and a non-table portion;
identifies a table result within the table portion of the document;
extracts contextual content associated with the table result from the non-table portion of the document; and
generates a data structure for the table result, wherein the data structure includes the table result and the contextual content associated with the table result.

9. The system of claim 8, wherein the table portion of the document includes a cell of a table within the document, and wherein the non-table portion of the document includes at least one of a header of the table, a caption associated with the table, and document text.

10. The system of claim 9, wherein the non-table portion of the document includes document text.

11. The system of claim 8, wherein the processor further:
identifies at least one argument associated with the table result within said extracted contextual content; and
determines a semantic role for each of the at least one argument associated with the table result.

12. The system of claim 11, wherein the processor further receives a domain semantic scheme associated with a subject of the document, wherein the domain semantic scheme includes a plurality of semantic roles, and said determined semantic role for each of the at least one argument is selected from the plurality of semantic roles.

13. The system of claim 11, wherein the processor further generates an association between each of the at least one argument and an entry corresponding to the respective argument in a database.

14. The system of claim 8, wherein the document includes at least one of a Portable Document Format (PDF) document, a Hypertext Markup Language (HTML) document, and an Extensible Markup Language (XML) document.

15. A computer program product for semantic analysis of table content, by a processor, the computer program product embodied on a non-transitory computer-readable storage medium having computer-readable program code portions stored therein, the computer-readable program code portions comprising:
an executable portion that receives a document that includes a table portion and a non-table portion;
an executable portion that identifies a table result within the table portion of the document;
an executable portion that extracts contextual content associated with the table result from the non-table portion of the document; and
an executable portion that generates a data structure for the table result, wherein the data structure includes the table result and the contextual content associated with the table result.

16. The computer program product of claim 15, wherein the table portion of the document includes a cell of a table within the document, and wherein the non-table portion of the document includes at least one of a header of the table, a caption associated with the table, and document text.

17. The computer program product of claim 16, wherein the non-table portion of the document includes document text.

18. The computer program product of claim 15, wherein the computer-readable program code portions further include:
an executable portion that identifies at least one argument associated with the table result within said extracted contextual content; and
an executable portion that determines a semantic role for each of the at least one argument associated with the table result.

19. The computer program product of claim 18, wherein the computer-readable program code portions further include an executable portion that receives a domain semantic scheme associated with a subject of the document, wherein the domain semantic scheme includes a plurality of semantic roles, and said determined semantic role for each of the at least one argument is selected from the plurality of semantic roles.

20. The computer program product of claim 18, wherein the computer-readable program code portions further include an executable portion that generates an association between each of the at least one argument and an entry corresponding to the respective argument in a database.

21. The computer program product of claim 15, wherein the document includes at least one of a Portable Document Format (PDF) document, a Hypertext Markup Language (HTML) document, and an Extensible Markup Language (XML) document.
